(19) United States
(12) Patent Application Publication
(10) Pub. No.: US 2016/0031196 A1
(43) Pub. Date: Feb. 4, 2016

(54) EXTRUDED PLASTIC PARTS BASED ON ADHESIVE FIRE PROOFED COATING ON TOP OF A PLASTIC SUBSTRATE AND THEIR PREPARATION PROCESS

(71) Applicant: Schneider Electric Industries SAS, Rueil Malmaison (FR)

(72) Inventor: Brigitte OHL, Champagnier (FR)

(73) Assignee: Schneider Electric Industries SAS, Rueil Malmaison (FR)

(21) Appl. No.: 14/804,412

(22) Filed: Jul. 21, 2015

(30) Foreign Application Priority Data
Jul. 31, 2014 (FR) 14 57420

(51) Int. Cl. B32B 27/32; C08K 3/32; B29C 47/06; B32B 25/14; B32B 27/08; B32B 25/08; C09D 123/12; B32B 27/36

(52) U.S. Cl. CPC B32B 27/32; C09D 123/12; C08K 3/32; B32B 27/36; B32B 25/14; B32B 27/365; B32B 27/08; B32B 25/08; B29C 47/065; B32B 2250/02; B32B 2250/24; B32B 2307/3065; B29K 2023/04; B29K 2023/10

(57) ABSTRACT

An extruded part comprising a substrate comprising at least one thermoplastic polymer, and a fire-retardant made of a fire-retardant material coating the substrate so that the external surface of the part exclusively consists of said fire-retardant material, wherein the fire-retardant layer adheres to the substrate, the fire-retardant material comprises a polyolefin and a non-halogenated fire-retardant compound, and the substrate comprises a mixture of a polyolefin and of at least one thermoplastic biopolymer and/or of at least one thermoplastic polymer, and an agent for compatibilization of the thermoplastic biopolymer and/or of the thermoplastic polymer with the polyolefin.

A method for preparing said part by co-extrusion.

Said part may notably be selected from among parts intended for handling and/or protecting cables and cable systems, such as trunkings and cable paths.

### TECHNICAL FIELD

The invention relates to extruded parts made of a plastic material comprising an adherent fire-retardant, flame-retardant coating.

More specifically, the invention relates to extruded parts comprising a substrate made of a thermoplastic polymeric matrix, said substrate being coated with a fire-retardant, flame-retardant layer which adheres to the substrate.

The invention further relates to a method for preparing, producing, these parts.

The extruded parts according to the invention are notably parts used in the electric industry, and more particularly parts intended for handling and/or protecting cables and cable systems, such as trunkings or cable paths which are prepared by extrusion.

### STATE OF THE PRIOR ART

Plastic materials, or more exactly thermoplastic polymers, are used in many sectors of the industry and notably in the electric industry.

For many uses of plastic materials, and in particular in the electric industry, a flame-retardant agent has to be incorporated thereto in order to give them fire resistance properties and to ensure that they meet European and French standards.

Thus, standard EN 50085-1: 2005 which specifies the rules and the tests for systems of chutes and systems of profiled conduits intended for accommodating insulated conductors, cables and other optional pieces of electric equipment, indicates in its paragraph 13.1.1 ( [symbol] Initiation of fire [symbol] ) the requirements which these parts should meet when they are subject to tests with an incandescent wire according to EN 60695-2-11.

The flammability performance GWFI (“Glow Wire Flammability Index”) required for parts such as casings and lids not maintaining in position portions conveying the current is, according to EN 50085-1: 2005, 650° C.

The glow wire flammability test is therefore considered as satisfied if, at the temperature of 650° C., no inflammation occurs, or if the persistent flames are extinguished in less than 30 seconds after withdrawal of the heating finger, and if the dropping of particles does not inflame the tissue paper positioned under the specimen.

Standard EN 50085-1: 2005 further indicates in its paragraph 13.1.3 (“Spread of fire”) the requirements which the parts should meet as regards propagation of fire.

Similar standards exist in the United States. The most currently used and commercially available fire-retardant, flame retardant agents are halogenated flame-retardant agents. However, these halogenated flame-retardant agents have drawbacks with respect to the environment or to health: problems of persistence, bioaccumulation and toxicity are reported and taken into consideration by non-government organizations; some of these flame-retardant agents based on halogenated substances are quoted in the list of substances of considerable concern.

In the future, increasingly strict regulations will come into effect and flame-retardant agents based on halogenated compounds may be gradually banned. Accordingly, the design of flame-retardant parts without any halogens is required for suppressing sanitary and environmental issues.

Fire-retardant agents, flame-retardant agents which are not based on halogenated substances are notably ammonium polyphosphates and metal hydroxides. But these non-halogenated flame-retardant agents also have drawbacks: for example, they may alter the mechanical properties of the plastic materials into which they are incorporated. They may also cause corrosion of the tooling used for shaping, forming, the plastic parts. Sometimes, their use is not compatible with the required temperatures for molding the parts.

Further, the flame-retardant agents and notably the halogenated flame-retardant agents are generally present in the totality of the volume of the plastic part to which it is intended to give flame-retardant properties, in other words, the flame-retardant agent is distributed in the bulk of the plastic forming the part. It may be stated that the part is a [symbol] one-piece [symbol] part. This is notably the case of trunkings or cable paths which are shaped, formed, by extrusion of [symbol] one-piece [symbol] profiles from granules.

The presence of a flame-retardant agent, notably a halogenated flame-retardant agent, in the bulk of the plastic may compromise the recyclability of the plastic parts at the end of their lifetime.

Indeed, many plastic recyclers do not accept plastic parts containing additives which are considered as suspect from the point of view of their toxicity. These compounds, considered as pollutants of plastics to be recycled, prevent their recycling and this even in the case of a system for recycling plastic wastes for producing energy.

Thus, most parts in plastic used in the electric industry, which have to meet strict standards as regards fire resistance, are not recyclable because of their one-piece structure containing a flame-retardant agent, notably a halogenated flame-retardant agent, in the bulk of the plastic, and cannot be described as parts [symbol] respectful of the environment [symbol] .

In order to solve the problems of the one-piece parts having fire resistance properties, a part comprising a substrate in at least one thermoplastic polymer and a flame-retardant material layer coating the substrate has been proposed in document EP-A1-2 565 009, wherein the flame-retardant material comprises a polymeric mixture of a polyolefin and of a polyamide, and a non-halogenated flame-retardant compound.

The part described in this document has a specific structure, with a substrate and a specific intumescent layer on this substrate. This structure may be described as a core-skin structure.

In other words, in the part of this document, one passes from a [symbol] one-piece [symbol] structure with the flame-retardant agent incorporated into the bulk of the plastic, to surface functionalization which provides the latter with a fire resistance property by an intumescence effect.

The parts of this document are exclusively prepared by a multi-material injection method, in which the totality of the surfaces of the substrate in a thermoplastic polymer is coated with the intumescent flame-retardant layer. These parts are mainly casings or covers of electric equipment, appliances.

In the method applied in this document, it is not necessary that the material which forms the core of the part on the one hand and the material which forms the skin of the part on the other hand be compatible.

The teachings of this document can absolutely not be applied to the parts prepared by extrusion.

The parts prepared by extrusion are notably parts intended for handling or protecting cables and cable systems, such as cable trunkings or paths.

These parts, such as trunkings, presently available on the market actually have the particularity of being shaped, formed, by extrusion of one-piece profiles from polymer granules.

Most often, formulations of polymers based on PVC (polyvinyl chloride) of a rigid quality are used, which are intrinsically flame-retardant.

Now, PVC is presently strongly questioned, notably by powerful NGOs.

Indeed, PVC produces opaque fumes which prevent evacuation of sites in the case of a fire.

Further, it is synthesized from a monomer, vinyl chloride which is classified as [symbol] carcinogenic for humans [symbol] by the IARC (group 1).

Further, at the stage of the end of their lifetime, PVC wastes are often treated in [symbol] non-official [symbol] systems, by uncontrolled incineration, and they are suspected of then emitting dioxin.

In certain countries such as the Scandinavian countries, the use of PVC is banned for certain sensitive applications.

Instead of PVC, it is possible to use a mixture of a polycarbonate PC and of a fire-proofed acrylonitrile-butadiene-styrene ABS copolymer (PC ABS, FR), without any halogenated flame retardant. Such a mixture is available commercially.

However, replacing PVC by the PC ABS, FR mixture is an expensive solution because of the high cost of the PC ABS, FR mixture available commercially, which is at least twice greater than that of PVC, and because of its difficulty to be extruded, in particular for instability reasons upon shaping by extrusion.

Further, these difficulties related to the [symbol] process [symbol] have a negative impact on the economical result of the operation for manufacturing the part.

Finally, environmentally, this solution may appear as a questionable solution since the amount of energy required during the synthesis of the polymers of the mixture, and the produced CO₂ emissions during this synthesis are considerable when they are compared with the same parameters during the manufacturing of PVC.

There also exist formulations based on poly(lactic acid) PLA—which is a polymer obtained from renewable resources—made fire-proof without any halogen. However, the durability of this polymer is not sufficient for use in an electro-technical product.

Indeed, certain formulations based on PLA are intrinsically sensitive to aging. Fire-proofing of these formulations by adding a metal hydroxide may increase the risk of premature degradation by hydrolysis of the polymer.

Therefore considering the foregoing, there exists a need for extruded parts based on thermoplastic polymers which have fire-retardant, flame-retardant properties and which do not contain any halogenated fire-retardant, flame-retardant agents.

There also exists a need for extruded parts based on thermoplastic polymers which may be easily recyclable, which are accepted in recycling systems and for which the fire-retardant properties are compliant with the standards, or even improved.

Further, there exists a need for extruded parts which are manufactured with non-toxic materials, not having any negative effects on health and having a small impact on the environment.

It would notably be desirable if these parts were made with materials having a small impact on CO₂ emissions in order to contribute to reducing the greenhouse effect and to avoid the climate changes which ensue therefrom.

Finally, there exists a need for extruded parts which are stable over time and long-lasting.

Further, there exists a need for a method for preparing such parts which is simple, reliable, includes a limited number of steps and which requires little capital.

The goal of the present invention is to provide fireproof, flameproof, extruded parts based on thermoplastic polymers which inter alia meet the needs and requirements listed above.

The goal of the present invention is also to provide a method for preparing such parts which inter alia meets the needs and requirements listed above for such a method.

The goal of the present invention is further to provide parts based on thermoplastic polymers which have fire-retardant, flame-retardant properties, and a method for preparing these parts; these parts and this method not having the drawbacks, defects, limitations and disadvantages of the parts and methods of the prior art and solving the problems of the parts and methods of the prior art.

### SUMMARY OF THE INVENTION

This goal and further other ones are achieved according to the invention by an extruded part comprising a substrate comprising at least one thermoplastic polymer, and a fire-retardant layer, flame-retardant layer made of a fire-retardant, flame-retardant material coating the substrate so that the external surface of the part exclusively consists of said fire-retardant material, in which the fire-retardant layer adheres to the substrate, the fire-retardant material comprises a polyolefin and a non-halogenated fire-retardant compound, and the substrate comprises a mixture of a polyolefin and of at least one thermoplastic biopolymer and/or of at least one thermoplastic polymer, and an agent for compatibilization of the thermoplastic biopolymer and/or for the thermoplastic polymer with the polyolefin.

The term of [symbol] compatibilization agent [symbol] is widely used in the field of polymers and has a well-established meaning.

Preferably, the thermoplastic polymer of the substrate totally or partly stems from recycling.

Still preferably, the thermoplastic polymer of the substrate stems from recycling by at least 50% by mass.

The extruded part according to the invention has a specific structure, with a substrate and a fire-retardant, flame-retardant layer on this substrate. This structure may be described as a core-skin structure.

Further, according to the invention, the fire-retardant, flame-retardant layer is made of a specific material, while the substrate comprises a mixture of specific compounds, i.e. a mixture of a polyolefin and of at least one thermoplastic biopolymer and/or of at least one thermoplastic polymer, preferably totally or partly stemming from recycling, and a compatibilization agent.

The part according to the invention has never been described nor suggested in the prior art; it meets the needs and requirements listed above and provides a solution to the aforementioned problems.

First of all, an extruded part with a core-skin structure has never been described in the prior art. Indeed, document EP-A1-2 565 009 of course describes a part which has a core-skin structure, but this is a part prepared by a multi-material injection method which is a totally different technique from extrusion.

Next, the combination of specific materials which form the fire-retardant layer and the substrate according to the invention is neither described nor suggested in the prior art notably for extruded parts.

Actually, the substrate comprises generally polar materials, which a priori are naturally incompatible with the apolar polyolefin of the fire-retardant material of the fire-retardant layer. These polar materials are a thermoplastic biopolymer and/or at least one thermoplastic polymer, preferably totally or partly stemming from recycling. The addition according to the invention of a polyolefin to these materials a priori naturally incompatible with the material of the fire-retardant layer surprisingly gives the possibility of making the material of the substrate and the fire-retardant material of the fire-retardant layer compatible with each other.

Because of the thereby ensured compatibility between the material of the substrate and the material of the fire-retardant layer, excellent adhesion is obtained according to the invention between the substrate and the fire-retardant layer, an adhesion which is a fundamental condition so that the part according to the invention is prepared by extrusion, or more exactly by co-extrusion of the layer and of the substrate.

The compatibilization agent, as for it, gives the possibility of making both naturally incompatible polymers of the mixture of polymers of the substrate or of the core i.e., an apolar polyolefin on the one hand and a thermoplastic biopolymer and/or at least one thermoplastic polymer on the other hand, preferably totally or partly stemming from recycling, which generally consists of a polar polymer or of a mixture of polar polymers, compatible with each other.

It is specifically the specific combination of specific materials selected for the core, the substrate on the one hand and for the fire-retardant layer on the other hand, which surprisingly allows the making of the part according to the invention by extrusion.

Some of the advantages of the part according to the invention stem from the excellent intrinsic fire-resistance properties provided by the specific flame-retardant skin, layer, even if this layer does not contain any halogenated compound.

In the part according to the invention, with a core-skin structure, the fire-retardant agent is exclusively found in a surface layer of the part, and this is no longer a fire-retardant agent incorporated into the whole of the volume, in the bulk of the plastic.

In other words, according to the invention, one has passed from a [symbol] one-piece [symbol] structure with the fire-retardant, flame-retardant agent incorporated into the bulk of the plastic, to surface functionalization providing the latter with a fire-resistance, flame-resistance property because of the non-halogenated fire-retardant, flame-retardant agent present in the layer.

Such a [symbol] core-skin [symbol] structure gives the part according to the invention a whole series of advantages as compared with the extruded parts of the prior art with a <one-piece> structure. It was thus noticed surprisingly that the part with a [symbol] core-skin [symbol] structure according to the invention had a fire behavior superior to that of a part with a [symbol] one-piece [symbol] structure.

The relevant fire behavior is related to the standard EN 50085-1: 2005, paragraph 13.1.3 [symbol] spread of fire [symbol] .

Tests have shown that a formulation based on an organic matrix in majority consisting of PLA polymer and without any addition of fire-retardant agent does not meet the standard.

Also, it was shown that a formulation based on an organic matrix in majority consisting of polycarbonates PC in a mixture with acrylonitrile-butadiene-styrene ABS copolymers does not meet the requirements of the aforementioned standard.

The fire-resistance properties of the extruded part according to the invention being fundamentally due to the skin or surface layer, it is no longer necessary to incorporate fire-retardant additives into the core of the part, the substrate, for which it is no longer necessary to resort to plastics containing, in their bulk, fire-retardant agents and in particular undesirable halogenated fire-retardant agents, considering their environmental and health profile.

The part with a [symbol] core-skin [symbol] structure according to the invention also has a much greater recycling capability than that of the extruded parts with a one-piece structure of the prior art.

By adopting the [symbol] core-skin [symbol] structure according to the invention, the fire-retardant additive no longer requires substances based on halogens; and further the compounds providing fire resistance are localized at the surface, the problems mentioned above are solved. If need be, if the fire-retardant layer is too thick, it may optionally be withdrawn for example by abrasion (sanding), at the end of its lifetime as this is already ensured for certain paints.

All in all, the handling of the plastic parts at the end of their lifetime is greatly improved.

Advantageously, the polyolefin (both the polyolefin of the fire-retardant material of the layer and the polyolefin of the substrate) is selected from polyethylenes, polypropylenes and mixtures thereof.

Advantageously, the polyolefin of the fire-retardant material of the layer and the polyolefin of the substrate are identical which allows further improvement in the compatibility between the layer and the substrate.

Preferably, the polyolefin of the fire-retardant material of the layer and the polyolefin of the substrate, the core, are both selected from polypropylenes or both selected from polyethylenes.

PP (polypropylene) is particularly advantageous, in particular if this is a virgin [symbol] impact resistant [symbol] PP and/or stemming from recycling.

An example of a polypropylene which may be selected as a polyolefin of the substrate is the polypropylene available from TOTAL® under the name of Polypropylene PPC 7712.

Advantageously, the polyolefin of the substrate totally or partly stems from recycling.

Still preferably, the polyolefin of the substrate stems from recycling by at least 50% by mass.

The fire-retardant layer further comprises as an essential component, a non-halogenated fire-retardant, flame-retardant compound.

Preferably, the non-halogenated fire-retardant, flame-retardant compound is selected from ammonium polyphosphates.

Advantageously, the non-halogenated fire-retardant, flame-retardant compound represents from 5% to 40% by mass based on the total mass of the fire-retardant material constituting the fire-retardant layer, preferably from 10% to 30% by mass based on the total mass of the fire-retardant material constituting the fire-retardant layer (skin).

Advantageously, the fire-retardant material further comprises at least one additive which modifies one or several properties among the following properties of the layer: the aesthetical aspect, the color, the resistance of the surface of the layer to ageing (for example an anti-UV agent), the chemical resistance of the surface of the layer towards chemical substances such as olive oil, the surface roughness, the humidity barrier effect, the resistance to wear, the comparative tracking index, and the water uptake resistance.

These additives should of course be compatible with the other constituents of the layer and notably with the polyolefin.

Advantageously, one of the additives will be selected from coloring agents and pigments. A coloring agent or pigment will notably be incorporated into the fire-retardant layer in the case when the substrate or core has a color which is unsuitable for the part, this may in particular occur when the substrate or core comprises or is made of a polymer stemming from recycling. Indeed, the generally dark color of such a polymer stemming from recycling may thus be hidden by a colored or pigmented fire-retardant layer having a more pleasant color for example a white layer.

For example, it is possible to incorporate into the fire-retardant layer or more exactly in the polyolefin, such as polypropylene, used for preparing this layer, titanium oxide (TiO₂), for example between 1 and 5 parts by mass, in order to thereby obtain a final white part, a final white product.

Scratch resistance may be increased by resorting to glass beads, which may be silanized in order to allow good compatibilization with the polymeric matrix made of a polyolefin of the fire-retardant layer or skin.

Further, as the color and the aspect of the part are provided by the skin layer, it is possible to rationalize the supplies for the material making up the substrate: a single generic grade may be sufficient, since differentiation related to the color may be provided by the skin.

In addition to the role of an aesthetical surface of the fire-retardant layer or skin, for example made of virgin [symbol] PP FR [symbol] of a white color which gives the possibility of hiding the dark color of a recycled plastic, this layer my further play a protection barrier role by extending the lifetime of a biopolymer of the substrate. Thus, the fire-retardant layer or skin by protecting and insulating the core from external agents, greatly decreases the sensitivity of polymers like poly(lactic acid) to ageing and notably increases the lifetime of the part according to the invention. Further as the fire-retardant agent is found in the skin, it is not able to cause degradation of the polymers of the substrate.

In order to meet the conditions set by the standards as regards fire resistance, the fire-retardant layer totally coats the substrate, i.e. all the surfaces of the substrate are coated with the fire-retardant layer.

The fire-retardant material which constitutes, makes up the fire-retardant layer is easy to transform, chemically resistant and has excellent dimensional stability.

Advantageously, the fire-retardant layer has a thickness greater than or equal to 0.2 mm, preferably a thickness from 0.3 to 0.8 mm.

It is the final product which defines the thickness of the substrate, the core.

Most often this thickness of the substrate, core, is located between 1 and 2 mm and may range up to 3 mm.

Other advantages of the part according to the invention are not mainly due to its core-skin structure but rather to the nature of the materials which make up, constitute the part.

The part according to the invention does not contain any compounds considered as persistent, bio-accumulative or toxic, in particular the part considered as a whole, comprising the substrate and the fire-retardant layer is free of halogenated compounds ( [symbol] halogen free [symbol] ) such as of PVC.

By analogy with the DIN VDE 0472 (815) standard dedicated to cables, by part, layer or material free of halogenated compounds is meant that the chlorine, bromine contents, as well as the total chlorine and bromine content are less than 0.2%, and the fluorine content is less than 0.1%.

The fire-retardant layer of the part comprises a non-halogenated fire-retardant compound and a polyolefin. This layer is therefore free of halogens.

In the same way, the plastic material, the mixture of thermoplastic polymers forming the substrate does not contain any halogenated compounds, such as PVC, and the part according to the invention as a whole is free of halogen, which is essential with view to its possible recycling.

All the drawbacks already mentioned above of the one-piece extruded parts made of PVC like the production of opaque and toxic fumes which may probably contain dioxin are thereby avoided.

The part according to the invention is therefore entirely made from sound materials, which do not cause, like PVC issues of the health or environmental order.

The substrate of the part according to the invention comprises a mixture of a polyolefin and of at least one thermoplastic biopolymer and/or of at least one thermoplastic polymer preferably totally or partly stemming from recycling. As this was seen above, the substrate does not contain any fire-retardant compound in the bulk since this fire-retardant compound is found in the skin of the part.

By biopolymer, is meant a polymer stemming from bioresources, i.e. exclusively stemming from living organisms, generally plant organisms, or a polymer synthesized from renewable resources, generally from plant resources.

Advantageously, the substrate comprises from 35% to 55% by mass, preferably 45% by mass of polyolefin(s), from 40% to 60% by mass, preferably 50% by mass of thermoplastic biopolymer(s) and/or thermoplastic polymer(s) preferably totally or partly stemming from recycling, and from 3% to 10% by mass, preferably 5% by mass of a compatibilization agent, based on the total mass of the substrate.

The part according to the invention therefore generally comprises a large proportion of thermoplastic biopolymer(s) and/or thermoplastic polymer(s) stemming from recycling. Consequently, the part according to the invention has a low impact on the environment. If the polyolefin of the substrate and optionally the polyolefin of the flame-retardant layer stem from recycling, this impact is even less.

In this way, the part may be described as a part [symbol] respectful of the environment [symbol] since the mixture of polymers from which stems its substrate minimizes the demand for exhaustible fossil resources (petroleum). Further, the use of recycled plastics for the core is a means for reducing the price of this substrate or core and therefore of the final part.

At the end of its lifetime, the part according to the invention may easily be recycled as a plastic of second generation.

Advantageously, the thermoplastic biopolymer is selected from poly(lactic acids) (PLAs).

An example of a poly (lactic acid) (PLA) is the product marketed by Natureplast® under the name of PLE 001.

Advantageously, the thermoplastic polymer preferably totally or partly stemming from recycling is selected from among acrylonitrile-butadiene-styrene (ABS) copolymers, and mixtures of polycarbonates PC and of acrylonitrile-butadiene-styrene (ABS) copolymers.

An example of a recycled acrylonitrile-butadiene-styrene (ABS) is SIKOFLEX® marketed by Ravago®.

An example of a mixture of polycarbonate (PC) and of recycled acrylonitrile-butadiene-styrene (ABS) is MABLEX® marketed by Ravago®.

By using acrylonitrile-butadiene-styrene (ABS) copolymers, and mixtures of polycarbonates PC and of acrylonitrile-butadiene-styrene (ABS) copolymers, stemming from recycling, all the problems of cost, energy consumption and negative impact on the environment of these virgin, novel, copolymers and mixtures are overcome.

Advantageously, the compatibilization agent is a random terpolymer of ethylene, methyl acrylate and glycidyl methacrylate.

Such a terpolymer is LOTADER AX8900® marketed by Arkema®.

The part according to the invention may be selected from parts intended for handling and/or protecting cables and cable systems, such as trunkings and cable paths.

The part according to the invention, such as a trunking, may be used instead and in place of existing products, in particular in environments such as sites or buildings visited by the public where particular care is taken for preserving the health of people.

The parts according to the invention may also be advantageously used in so-called [symbol] green [symbol] ecological residential buildings.

The part according to the invention is generally made by a co-extrusion method.

The invention therefore also relates to a method for preparing the part as described in the foregoing, comprising at least one step wherein simultaneous extrusion (or co-extrusion), is carried out in a co-extrusion die, the profile of which is adapted to the shape of the part, of a first stream of molten material intended to form the substrate, prepared in a first extruder, and of a second stream of molten material intended to form the flame-retardant layer, prepared in a second extruder.

The co-extrusion method is already widely used in industry.

The duration of a cycle of a co-extrusion process is close to that of a simple shaping, forming, by extrusion.

The only additional investment required as compared with a simple extrusion method is optionally the acquisition of a second extrusion facility.

As this has already been mentioned, the use of recycled plastics is also a means for reducing the price of the core of the part according to the invention.

Other effects and advantages of the invention will become better apparent upon reading the detailed description which follows, made as an illustration and not as a limitation in which are notably discussed particular embodiments of the invention as examples describing the manufacturing of parts according to the invention and giving the results of fire resistance tests conducted on these parts.

### DETAILED DISCUSSION OF PARTICULAR EMBODIMENTS

In the following the manufacturing of a part according to the invention is described, in which the co-extrusion technology is used.

The manufacturing of a part according to the invention generally comprises three steps.

In a first step, the material intended to form the core of the part or substrate is prepared.

In a second step, which may follow, precede the first step or be simultaneous with the first step, the material intended to form the flame-retardant layer or skin of the part according to the invention is prepared, such as a chute.

In a third step, the part with the core-skin structure according to the invention such as a chute, is prepared by co-extrusion.

In the first step, one first of all begins by preparing granules for which the composition corresponds to the composition of the substrate, core of the part according to the invention as described above.

These granules therefore comprise a mixture of a polyolefin, of at least one thermoplastic biopolymer and/or of at least one thermoplastic polymer preferably totally or partly stemming from recycling, and a compatibilization agent.

These granules are prepared by feeding an extruder through a hopper, with the different constituents listed above intended to form the granules.

Thus, in the case when it is desired to prepare a part with a core rich in renewable materials, the extruded mixture may for example have the following composition in % by mass:
Poly (lactic acid) (PLA), such as PLE 001 marketed by Natureplast®: 50%.
Polypropylene (PP), such as PPC 7712 marketed by Total®: 45%.
Compatibilization agent, such as LOTADER AX8900® marketed by Arkema: 5%.

In the case when it is desired to prepare a part with a core rich in recycled plastic materials stemming from products at the end of their lifetime, the extruded mixture may for example have the following composition in % by mass:
Recycled acrylonitrile-butadiene-styrene (ABS), such as SIKOFLEX® marketed by Ravago®, or a mixture of polycarbonate (PC) and of acrylonitrile-butadiene-styrene (ABS) such as MABLEX® marketed by Ravago® or BAYBLEND® T85XF marketed by Bayer Material Science: 50%.
Polypropylene (PP), such as PPC 7712 marketed by Total®: 45%.
Compatibilization agent, such as LOTADER AX8900® marketed by Arkema: 5%.

This extruder may for example be a single-screw or twin-screw extruder.

The obtained extrudate is then cooled and then subject to a pelleting operation, a granulation operation, in order to obtain granules generally having a cylinder shape, and of a generally standard size (average diameter of 2 mm for an average height of 2 and 5 mm).

In the second step, granules are prepared for which the composition corresponds to the composition of the flame-retardant layer according to the invention as described above.

These granules are prepared for example from a commercial formulation which is used as a base matrix. This is for example material from A. Schulman® referenced as Polyflam RPP 490 CS1.

The granules generally comprise at least one additive which modifies one or several properties of the layer: the aesthetical aspect, the color, the resistance to ageing of the surface of the layer (for example an anti-UV agent), the chemical resistance of the surface of the layer towards chemical substances such as olive oil, the surface roughness, the humidity barrier effect, the resistance to wear, the comparative tracking index and the water uptake resistance.

In the third step, parts according to the invention with a core-skin structure are then prepared, for example bilayer profiles forming a trunking, by co-extrusion of the material intended to form the core of the part which was prepared during the first step, and of the material intended to form the fire-retardant layer or skin of the part, such as a trunking, which has been prepared during the second step.

Co-extrusion is achieved by using two extruders which are connected to a co-extrusion die to which are simultaneously conveyed the flow of molten material constituting the core and the flow of molten material constituting the skin of the part.

More specifically, both extruders may be single-screw extruders and they may each include three heating areas, the temperature of which is regulated.

The second extruder is fed, via a hopper, with the granules prepared as described above, intended to form the skin, the fire-retardant layer, while the first extruder is fed, via a hopper with the mixture intended to form the core of the part.

Of course, the roles of the first and of the second extruder may be reversed.

The flow of molten material intended to form the skin formed in the second extruder and the flow of molten material intended to form the core formed in the first extruder are conveyed via channels in a co-extrusion die, the temperature of which is regulated, for example by means of three heating areas.

The die has a shape which is adapted to that of the part which one intends to prepare such as a trunking.

At the outlet of the co-extrusion die a part according to the invention is thereby obtained, having the intended core-skin, bilayer structure.

The invention will now be described with reference to the following examples given as an illustration and not as a limitation.

### EXAMPLES

### Example 1

In this example, a part according to the invention is prepared for which the core is rich in material of renewable origin by the method described above.

In the first step, first of all one begins by preparing granules, the composition of which corresponds to the composition of the substrate, core of the part according to the invention.

These granules are prepared by feeding an extruder with the different constituents intended to form the granules via a hopper.

This extruder is a twin-screw co-rotary extruder Brabender® provided with six heating areas ensuring regulation of the temperature.

In this example, as one wishes to prepare a part with a core rich in materials of renewable origin, the extruded mixture has the following composition in % by mass:
Poly (lactic acid) (PLA), PLE 001 marketed by Natureplast®: 50%.
Polypropylene (PP), PPC 7712 marketed by Total®: 45%.
Compatibilization agent, LOTADER AX8900® marketed by Arkema: 5%.

The obtained extrudate is then cooled and then subject to a tableting, granulating operation, for obtaining granules generally having a cylinder shape, and of a generally standard size (average diameter 2 mm for an average height of 2 and 5 mm).

The granules for which the composition corresponds to the composition of the fire-retardant layer according to the invention as described above are granules of a fire-proofed polypropylene without any halogen, available commercially under the name of POLYFLAM® RIPP 490.

The granules of POLYFLAM generally have a cylinder shape with an average diameter of 2 mm for an average height of 2 and 5 mm.

Parts according to the invention with a core-skin structure i.e. bilayer profiles forming a chute are then manufactured.

These parts are manufactured by co-extrusion of the material intended to form the core of the part which was prepared during the first step, and of the material intended to form the fire-retardant layer or skin of the part, i.e. POLYFLAM. Co-extrusion is achieved by using two single-screw extruders YVROUD of a diameter of 30 mm which are connected to a co-extrusion die towards which are simultaneously conveyed the flow of molten material constituting the core and the flow of molten material constituting the skin of the part.

The first extruder is fed, via a hopper, with the granules prepared as described above intended to form the core of the part, while the second extruder is fed, via a hopper, with granules of POLYFLAM® intended to form the skin, the flame-retardant layer of the part.

The roles of the first and of the second extruders may be reversed.

The flow of molten material intended to form the core, substrate, formed in the first extruder and the flow of molten material intended to form the skin, the flame-retardant layer formed in the second extruder, are conveyed towards a co-extrusion die, the temperature of which is regulated, by means of three heating areas.

The die allows shaping of a 60 mm co-extruded two-component strip, with a skin layer with a thickness of 1 mm constituted by the material described above, i.e. POLYFLAM® RIPP 490 and a core layer of 0.8 mm constituted by the material described above.

This example proves that it is actually possible to manufacture the parts according to the invention with a co-extrusion method.

This example further proves that good quality adhesion exists between the core and the skin of the part according to the invention.

Actually, the bi-layer structure obtained was cut perpendicularly to the surface and then observed with a microscope. The analysis of the interface shows that no void or detachment exists between the surface layer and the substrate forming the core.

### Example 2

In this example, a part according to the invention is prepared for which the core is rich in plastic materials from recycling, with the method described above.

In the first step, first of all one begins by preparing granules for which the composition corresponds to the composition of the substrate, core of the part according to the invention.

These granules are prepared by feeding an extruder with the different constituents intended to form the granules via a hopper.

This extruder is a twin-screw co-rotary extruder Brabender® provided with six heating areas ensuring regulation of the temperature.

In this example, as it is desired to prepare a part with a core rich in a material of renewable origin, the extruded mixture has the following composition in % by mass:
A mixture of Acrylonitrile-Butadiene-Styrene (ABS®) copolymer and of polycarbonate, BAYBLEND® T 85 XF marketed by Bayer Material Science®: 50%.
Polypropylene (PP), PPC 7712 marketed by Total®: 45%.
Compatibilization agent, LOTADER AX8900® marketed by Arkema: 5%.

The obtained extrudate is then cooled and then subject to a pelleting, granulating operation, in order to obtain granules generally having a cylinder shape, and of a generally standard size (average diameter of 2 mm for an average height of 2 and 5 mm).

The granules for which the composition corresponds to the composition of the flame-retardant layer according to the invention as described above are granules of a fireproofed polypropylene without any halogen available commercially under the name of POLYFLAM® RIPP 490.

The granules of POLYFLAM® generally have a cylinder shape, with an average diameter of 2 mm for an average height of 2 and 5 mm. Parts according to the invention with a core-skin structure, i.e. bilayer profiles forming a trunking, are then manufactured.

These parts are manufactured by co-extrusion of the material intended to form the core of the part which was prepared during the first step, and of the material intended to form the fire-retardant layer or skin of the part, i.e. POLYFLAM®. Co-extrusion is achieved by using two single-screw extruders YVROUD of a diameter of 30 mm which are connected to a co-extrusion die to which are simultaneously conveyed the flow of molten material constituting the core and the flow of molten material constituting the skin of the part.

The first extruder is fed, via a hopper, with the granules prepared as described above intended to form the core of the part, while the second extruder is fed, via a hopper, with the granules of POLYFLAM® intended to form the skin, the fire-retardant layer of the part.

The roles of the first and of the second extruders may be reversed.

The flow of molten material intended to form the core, substrate, formed in the first extruder and the flow of molten material intended to form the skin, the fire-retardant layer, formed in the second extruder are conveyed towards a co-extrusion die, the temperature of which is regulated, by means of three heating areas.

The die allows shaping of a 60 mm co-extruded two-component strip, with a skin layer with a thickness of 1 mm constituted by the material described above, i.e. the material from A. Schulman® referenced as POLYFLAM RPP 490 CS1, and a core layer of 0.8 mm constituted by the material described above.

This example proves that it is actually possible to manufacture the parts according to the invention with a co-extrusion method.

This example further proves that good quality adhesion exists between the core and the skin of the part according to the invention.

Actually, the bi-layer structure obtained was cut perpendicularly to the surface and then observed with a microscope. The analysis of the interface shows that there does not exist any void or detachment between the surface layer and the substrate constituting the core.

### Example 3

In this example, the fire behavior of the parts prepared in Examples 1 and 2 is studied.
First of all glow wire tests are conducted on the parts according to the invention of Examples 1 and 2.

The tests were conducted according to the IEC 60695-2-13 standard in order to determine the Glow Wire Ignition Temperature (“GWIT”) and according to the IEC 60695-2-11 standard for determining the Glow Wire Flammability Index (“GWIF”).

For the part according to the invention of Example 1 and for the part according to the invention of Example 2, a value of GWFI of 750° C. and a value of GWIT of 775° C. is measured every time.

The values of GWIT and GWFI of the parts according to the invention, of Examples 1 and 2, determined according to the standards (IEC 60695-2-13 and 60695-2-11) therefore meet the requirements set by the European standard EN 50085-1: 2005 paragraph 13.1.1.

Actually, the standard EN 50085-1: 2005 specifies the rules and the tests for the chute systems and profile-conduit systems intended for accommodating insulated conductors, cables and other optional pieces of electric equipment, and paragraph 13.1.1 ( [symbol] Initiation of fire [symbol] ) specifies that for non-metal or composite parts of components of systems which are not required for maintaining the current-transporting parts in place and the grounding circuit parts in position, but which are in contact with the latter, the glow wire test (according to 60695-2-11) is conducted at a temperature of 650° C. This temperature therefore defines the minimum GWIF required by the standard EN 50085-1: 2005 and is widely exceeded by the parts according to the invention.
Fire propagation tests were then conducted ( [symbol] Spread of fire [symbol] ) on the parts according to the invention of Examples 1 and 2.

These tests were conducted according to the EN 50085-1: 2005 standard, paragraph 13.1.3 ( [symbol] Spread of fire [symbol] ) in which the sample to be tested is exposed to flames for 60 s±2 s.

According to this standard, it is considered that the sample has passed the test successfully if it does not ignite (no observed ignition) or in the case when it ignites (ignition) if the flame is extinguished within 30 seconds after withdrawing the test flame (i.e. the burner) and if the fall of particles does not cause ignition of the tissue paper placed under the specimen and if no trace of combustion is observed at 50 mm under the upper clamp.

With the parts according to the invention of Examples 1 and 2, no persistence of the flame beyond 60 seconds was observed, i.e. the part is ignited but after removal of the test flame (after 60 seconds), the flame (of the part) was extinguished straightaway.

The parts according to the invention therefore successfully passed the fire propagation tests.

1. An extruded part comprising a substrate comprising at least one thermoplastic polymer, and a fire-retardant layer made of a fire-retardant material coating the substrate so that the external surface of the part exclusively consists of said fire-retardant material, wherein the fire-retardant layer adheres to the substrate, the fire-retardant material comprises a polyolefin and a non-halogenated fire-retardant compound, and the substrate comprises a mixture of a polyolefin and of at least one thermoplastic biopolymer and/or of at least one thermoplastic polymer, and an agent for compatibilization of the thermoplastic biopolymer and/or of the thermoplastic polymer with the polyolefin.

2. The part according to claim 1, wherein the thermoplastic polymer of the substrate totally or partly stems from recycling, preferably the thermoplastic polymer of the substrate by at least 50% by mass stems from recycling.

3. The part according to claim 1, wherein the polyolefin is selected from polyethylenes, polypropylenes and mixtures thereof.

4. The part according to claim 1, wherein the polyolefin of the fire-retardant material of the layer and the polyolefin of the substrate are identical.

5. The part according to claim 1, wherein the polyolefin of the substrate totally or partly stems from recycling.

6. The part according to claim 1, wherein the non-halogenated fire-retardant compound is selected from ammonium polyphosphates.

7. The part according to claim 1, wherein the non-halogenated fire-retardant compound represents from 5% to 40% by mass, preferably from 10 to 30% by mass, based on the total mass of the fire-retardant material which constitutes the fire-retardant layer.

8. The part according to claim 1, wherein the flame-retardant material further comprises at least one additive which modifies one or several properties from among the following properties of the layer: the esthetical aspect, the color, the resistance of the surface of the layer to aging, the chemical resistance of the surface of the layer towards chemical substances such as olive oil, the surface roughness, the humidity barrier properties, the resistance to wear, the comparative tracking index, and the water uptake resistance.

9. The part according to claim 1, wherein the fire-retardant layer has a thickness greater than or equal to 0.2 mm, preferably a thickness from 0.3 to 0.8 mm.

10. The part according to claim 1, wherein the substrate comprises from 35% to 55% by mass, preferably 45% by mass of polyolefin(s), from 40 to 60% by mass, preferably 50% by mass, of thermoplastic biopolymer(s) and/or of thermoplastic polymer(s), and from 3% to 10% by mass, preferably 5% by mass of a compatibilization agent, based on the total mass of the substrate.

11. The part according to claim 1, wherein the thermoplastic biopolymer is selected from among poly(lactic acid)s (PLAs).

12. The part according to claim 1, wherein the thermoplastic polymer is selected from among acrylonitrile-butadiene-styrene (ABS) copolymers, and mixtures of polycarbonates PC and of acrylonitrile-butadiene-styrene (ABS) copolymers.

13. The part according to claim 1, wherein the compatibilization agent is a random terpolymer of ethylene, methyl acrylate and glycidyl methacrylate.

14. The part according to claim 1, which is selected from among parts intended for handling and/or protecting cables and cable systems, such as trunkings and cable paths.

15. A method for preparing the part according to claim 1, comprising at least one step wherein simultaneous extrusion is carried out, in a co-extrusion die the profile of which is adapted to the shape of the part, of a first stream of molten material intended to form the substrate, prepared in a first extruder, and of a second stream of molten material intended to form the fire-retardant layer, prepared in a second extruder.
